(19) United States
(12) Patent Application Publication
(10) Pub. No.: US 2023/0144930 A1
(43) Pub. Date: May 11, 2023

(54) HARQ-ACK DELAY TO SUPPORT 14 HARQ PROCESSES IN ENHANCED MACHINE TYPE COMMUNICATIONS

(71) Applicant: Nokia Technologies Oy, Espoo (FI)

(72) Inventors: David BHATOOLAUL, Swindon, Wiltshire (GB); Rapeepat RATASUK, Invemess, IL (US)

(21) Appl. No.: 17/906,778

(22) PCT Filed: Feb. 10, 2021
(86) PCT No.: PCT/IB2021/051089

§ 371 Date: Sep. 20, 2022

Related U.S. Application Data
(60) Provisional application No. 63/002,768, filed on Mar. 31, 2020.

(51) Int. Cl. H04L 1/1825; H04L 1/1812; H04L 1/1607

(52) U.S. Cl. CPC H04L 1/1825; H04L 1/1812; H04L 1/1607

(57) ABSTRACT

A method, apparatus, and a computer-readable storage medium are provided for joint encoding of downlink control information (DCI) fields to support hybrid automatic request-acknowledgement (HARQ-ACK) delays for more than 10 HARQ processes (e.g., 14 HARQ processes) at a user equipment. In an example implementation, the method may include a user equipment (UE) determining a number of hybrid automatic repeat request (HARQ) processes configured at the UE and determining a HARQ acknowledgement (HARQ-ACK) delay value based at least on the number of HARQ processes configured at the UE and downlink control information (DCI) received from a network node.

### TECHNICAL FIELD

This description relates to wireless communications, and in particular, hybrid automatic repeat request (HARQ) techniques.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP or Evolved Node B (eNBs), provide wireless access within a coverage area or cell. In LTE, mobile devices, or mobile stations are referred to as user equipments (UE). LTE has included a number of improvements or developments.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT), and may offer new types of mission-critical services. Ultra-reliable and low-latency communications (URLLC) devices may require high reliability and very low latency.

### SUMMARY

Various example implementations are described and/or illustrated. The details of one or more examples of implementations are set forth in the accompanying drawings and the description below. Other features will be apparent from the description and drawings, and from the claims.

A method, apparatus, and a computer-readable storage medium are provided for joint encoding of downlink control information (DCI) fields to support hybrid automatic request-acknowledgement (HARQ-ACK) delays for more than 10 HARQ processes (e.g., 14 HARQ processes) at a user equipment. In an example implementation, the method may include a user equipment (UE) determining a number of hybrid automatic repeat request (HARQ) processes configured at the UE and determining a HARQ acknowledgement (HARQ-ACK) delay value based at least on the number of HARQ processes configured at the UE and downlink control information (DCI) received from a network node.

### BRIEF DESCRIPTION OF THE DRAWINGS

FIG. 1 is a block diagram of a wireless network according to an example implementation.

FIG. 2 illustrates a HARQ-ACK procedure to support at least 14 HARQ processes, according to an example implementation.

FIG. 3 illustrates a joint encoded state table that supports HARQ-ACK delays for at least 14 HARQ processes, according to an example implementation.

FIG. 4 is a flow chart illustrating a HARQ-ACK delay procedure to support at least 14 HARQ processes, according to an example implementation.

FIG. 5 is a block diagram of a node or wireless station (e.g., base station/access point or mobile station/user device/UE), according to an example implementation.

### DETAILED DESCRIPTION

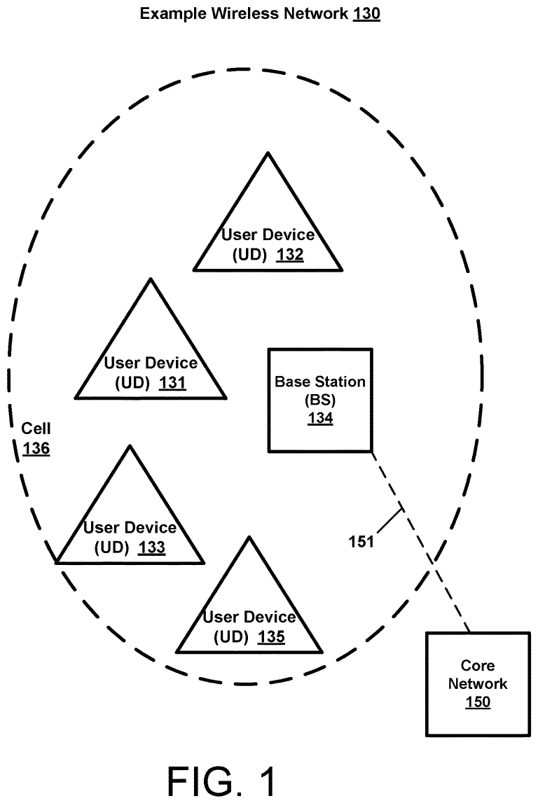

FIG. 1 is a block diagram of a wireless network 130 according to an example implementation. In the wireless network 130 of FIG. 1, user devices (UDs) 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a next-generation Node B (gNB) or a network node. At least part of the functionalities of an access point (AP), base station (BS), (e)Node B (eNB), or gNB may also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples, or any other wireless device. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example implementations or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC).

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC or machine to machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing up to e.g., 1 ms U-Plane (user/data plane) latency connectivity with 1-1e-5 reliability, by way of an illustrative example. Thus, for example, URLLC user devices/UEs may require a significantly lower block error rate than other types of user devices/UEs as well as low latency. Thus, for example, a URLLC UE (or URLLC application on a UE) may require much shorter latency, as compared to an eMBB UE (or an eMBB application running on a UE).

The various example implementations may be applied to a wide variety of wireless technologies or wireless networks, such as LTE, LTE-A, 5G, IoT, MTC, eMTC, eMBB, URLLC, etc., or any other wireless network or wireless technology. These example networks, technologies or data service types are provided only as illustrative examples.

Multiple Input, Multiple Output (MIMO) may refer to a technique for increasing the capacity of a radio link using multiple transmit and receive antennas to exploit multipath propagation. MIMO may include the use of multiple antennas at the transmitter and/or the receiver. MIMO may include a multi-dimensional approach that transmits and receives two or more unique data streams through one radio channel. For example, MIMO may refer to a technique for sending and receiving more than one data signal simultaneously over the same radio channel by exploiting multipath propagation. According to an illustrative example, multi-user multiple input, multiple output (multi-user MIMIO, or MU-MIMO) enhances MIMO technology by allowing a base station (BS) or other wireless node to simultaneously transmit or receive multiple streams to different user devices or UEs, which may include simultaneously transmitting a first stream to a first UE, and a second stream to a second UE, via a same (or common or shared) set of physical resource blocks (PRBs) (e.g., where each PRB may include a set of time-frequency resources).

Also, a BS may use precoding to transmit data to a UE (based on a precoder matrix or precoder vector for the UE). For example, a UE may receive reference signals or pilot signals, and may determine a quantized version of a DL channel estimate, and then provide the BS with an indication of the quantized DL channel estimate. The BS may determine a precoder matrix based on the quantized channel estimate, where the precoder matrix may be used to focus or direct transmitted signal energy in the best channel direction for the UE. Also, each UE may use a decoder matrix may be determined, e.g., where the UE may receive reference signals from the BS, determine a channel estimate of the DL channel, and then determine a decoder matrix for the DL channel based on the DL channel estimate. For example, a precoder matrix may indicate antenna weights (e.g., an amplitude/gain and phase for each weight) to be applied to an antenna array of a transmitting wireless device. Likewise, a decoder matrix may indicate antenna weights (e.g., an amplitude/gain and phase for each weight) to be applied to an antenna array of a receiving wireless device. This applies to UL as well when a UE is transmitting data to a BS.

For example, according to an example aspect, a receiving wireless user device may determine a precoder matrix using Interference Rejection Combining (IRC) in which the user device may receive reference signals (or other signals) from a number of BSs (e.g., and may measure a signal strength, signal power, or other signal parameter for a signal received from each BS), and may generate a decoder matrix that may suppress or reduce signals from one or more interferers (or interfering cells or BSs), e.g., by providing a null (or very low antenna gain) in the direction of the interfering signal, in order to increase a signal-to interference plus noise ratio (SINR) of a desired signal. In order to reduce the overall interference from a number of different interferers, a receiver may use, for example, a Linear Minimum Mean Square Error Interference Rejection Combining (LMMSE-IRC) receiver to determine a decoding matrix. The IRC receiver and LMMSE-IRC receiver are merely examples, and other types of receivers or techniques may be used to determine a decoder matrix. After the decoder matrix has been determined, the receiving UE/user device may apply antenna weights (e.g., each antenna weight including amplitude and phase) to a plurality of antennas at the receiving UE or device based on the decoder matrix. Similarly, a precoder matrix may include antenna weights that may be applied to antennas of a transmitting wireless device or node. This applies to a receiving BS as well.

In 3GPP R17, fourteen (14) HARQ processes are being introduced to support machine type communications (MTC), enhanced MTC (eMTC), and Internet of Things (IoT) enhancements. The increase in the number of HARQ processes to 14 (from 10) can significantly increase peak data rates and throughput. However, the support for 14 HARQ processes may require additional bits in DCI to support HARQ-ACK delays for 14 HARQ processes.

Several procedures have been proposed to support 14 HARQ processes. However, they have drawbacks. For example, when 14 HARQ processes are configured and 4-8 transport blocks (TBs) are to be transmitted, a user equipment (UE) may be required to transmit 3 ACK bundled responses (instead of optimal 2 ACK bundled responses). When all TBs for 14 HARQ processes are being used to achieve peak data rates, some of the HARQ process IDs may be out of order, and when HARQ process IDs (0-9) would appear, the delay may not be long enough to make use of the next batch of ACK-NACK responses because of the limited range of delays linked to the legacy HARQ process IDs (e.g., 0-9). In addition, retransmission of legacy process IDs may not use certain (new) subframes for retransmissions due to limited range of delays. Thus, an increased number of DCI bits have to be used to support more efficient scheduling and to avoid degrading DCI scheduling performance

Therefore, there is a desire and/or need to support HARQ-ACK delays for more than 10 HARQ processes (e.g., 14 HARQ processes) without increasing the number of DCI bits required for such support. In other words, there is a desire and/or need to support HARQ-ACK delays for 14 HARQ processes without increasing the size of HARQ-ACK delay field to 4 bits and/or while avoiding the need for an additional 1 bit to support physical downlink shared channel (PDSCH) offset of 7. A PDSCH offset may refer to a time offset between the transmission of machine type communications (MTC) physical downlink control channel (MPDCCH) and the PDSCH. A HARQ-ACK delay may be defined as a time delay or offset between the reception of the PDSCH and the transmission of the HARQ-ACK.

The present disclosure describes an example implementation which includes joint encoding of DCI fields to support (at least) one additional HARQ-ACK delay value (e.g., HARQ-ACK delay value of 8) without increasing the size of the DCI. In an example implementation, the method may include a UE determining a number, for example, a maximum number, of hybrid automatic repeat request (HARQ) processes configured at the UE and determining a HARQ-ACK delay value based at least on the number of HARQ processes configured at the UE and downlink control information (DCI) received from a network node. In some implementations, for example, the HARQ-ACK delay value may be determined from a plurality of fields of DCI that may be jointly encoded. The plurality of DCI fields may include one or more of a PDSCH offset field, a HARQ-ACK delay field, a HARQ process number, and/or a HARQ-ACK bundling flag.

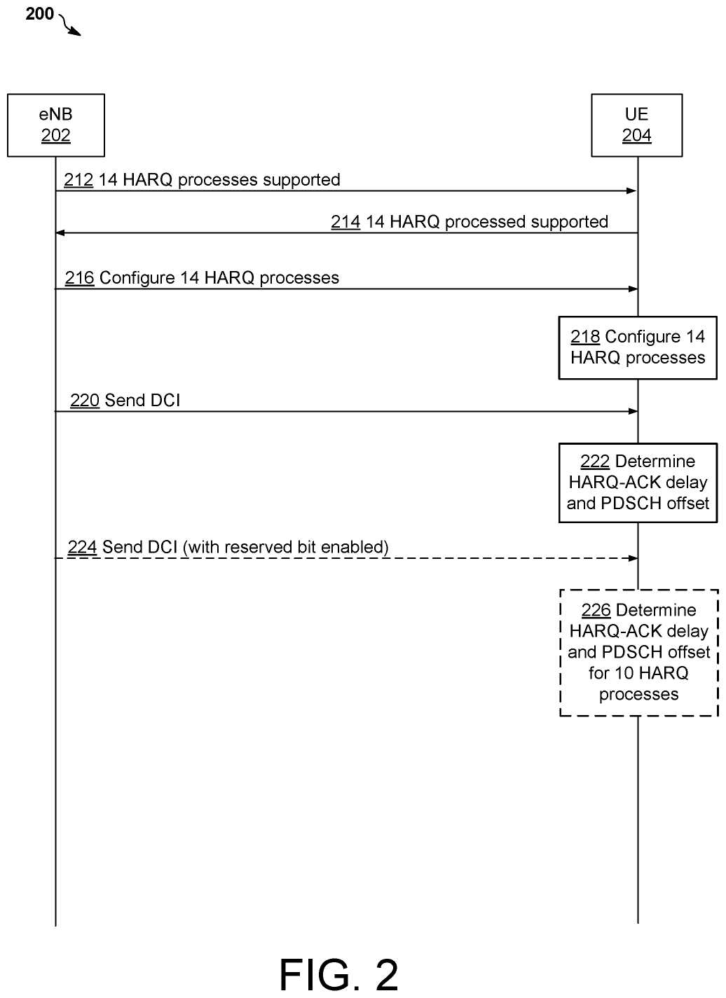

FIG. 2 illustrates a HARQ-ACK procedure 200 to support at least 14 HARQ processes (or more than 10 HARQ processes), according to an example implementation.

At 212, an eNB, e.g., eNB 202, may broadcast information that the eNB may support 14 HARQ processes. In some implementations, for example, the eNB may broadcast a message in a radio resource control (RRC) information element (IE) of a system information block (SIB) that the eNB supports 14 HARQ processes.

At 214, a UE, e.g., UE 204, in response to receiving of the broadcast message from the eNB, may respond that the UE can support 14 HARQ processes as well. It should be noted that the UE may support 14 HARQ processes (e.g., 14 HARQ process configuration) in addition to 10 HARQ process configuration. In some implementations, for example, the UE may transmit this information via UE capability information as part of the initial access procedure.

At 216, eNB 202, in response to receiving information from the UE that the UE may support 14 HARQ processes, may send a configuration message to the UE so that the UE may be configured to support 14 HARQ processes. In some implementations, for example, the eNB may configure the UE to use 14 HARQ processes via an RRC message, e.g., an RRC connection sett or RRC connection reconfiguration message.

At 218, UE 204, upon receiving the configuration message from eNB, may configure the UE to support 14 HARQ processes.

At 220, eNB 202 may send downlink control information (DCI) to the UE. In an example implementation, the DCI may be sent to the UE via a PDCCH or a MPDCCH. In some implementations, for example, the DCI may include several fields, for example, a new data indicator (NDI), a HARQ process number, a HARQ-ACK bundling flag, a HARQ-ACK delay, etc.

At 222, UE 204, upon receiving the DCI from the eNB, may determine HARQ-ACK delay and PDSCH offset for the 14 HARQ processes. In some implementations, for example, as the UE is aware that it is configured to support 14 HARQ processes (as described above in reference to 218), UE 204 may interpret that a plurality of fields of the DCI being jointly encoded. In an example implementation, the plurality of fields that the UE may consider as being jointly encoded include one or more of: a HARQ-ACK bundling flag, a HARQ-ACK delay, a PDSCH offset, and/or a HARQ process number. In some implementations, the size of HARQ-ACK bundling flag, HARQ-ACK delay, PDSCH offset, and HARQ process number may be 1 bit, 3 bits, 1 bit, and 4 bits, respectively.

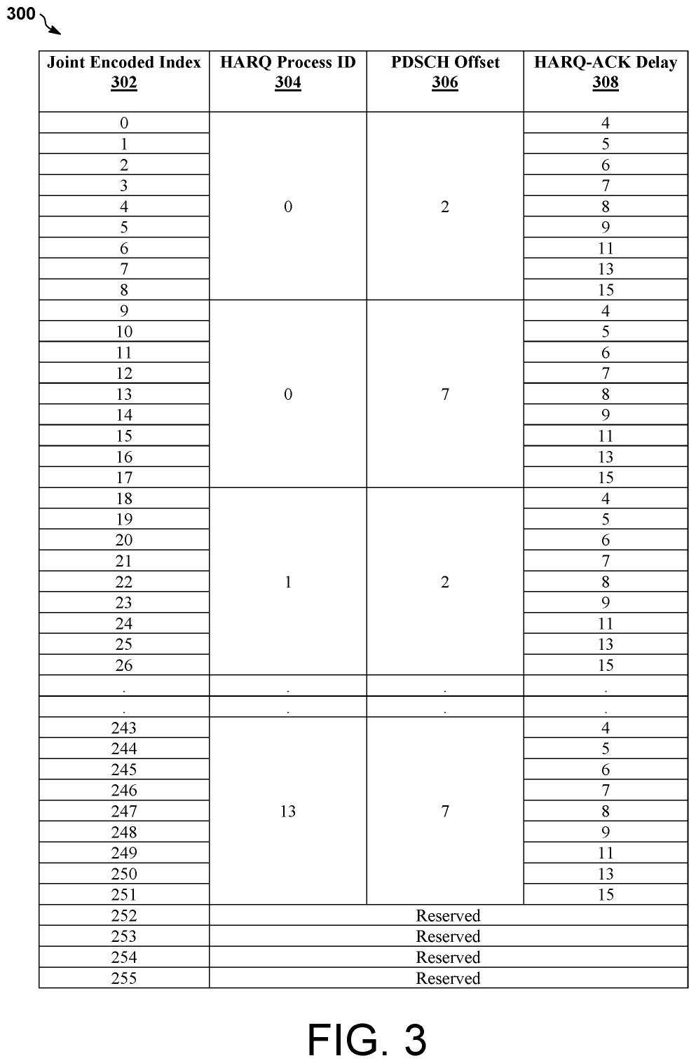

The UE may decode the jointly encoded fields of the DCI described above to determine joint encoded index values which indicate HARQ-ACK delays and PDSCH offsets for the 14 HARQ processes, further described in detail in reference to FIG. 3. In some implementations, for example, the UE may use the determined HARQ-ACK delays and PDSCH offsets to transmit ACK/NACKs to the eNB accordingly.

Optionally, in some implementations, at 224, eNB 202 may send a message to the UE to switch the UE from 14 HARQ process configuration to 10 HARQ process configuration. In some implementations, for example, a reserved state of a joint encoded state table (illustrated in FIG. 3) may be used by the eNB to signal such RRC reconfiguration, e.g., switching to 10 HARQ processes, without the need for longer RRC signalling. In an example implementation, the switching may be based on UE coverage enhancement level (e.g., without the need for the UE to use all HARQ processes due to repetition). In another example implementation, the UE may be switched back to 14 HARQ processes via an RRC reconfiguration message.

At 226, UE 202, upon receiving the DCI with the reserved bit of the joint encoded table value enabled, may determine HARQ-ACK delays and PDSCH offsets for 10 HARQ processes. In some implementations, for example, the UE may determine HARQ-ACK delays for 10 HARQ processes based at least on the HARA-ACK delay field of the DCI received from the eNB.

Thus, the UE may be configured to support 14 HARQ processes without increasing the size of DCI or increased number of bits.

FIG. 3 illustrates a joint encoded state table 300 that supports HARQ-ACK delays for at least 14 HARQ processes, according to an example implementation.

In some implementations, for example, an eNB, e.g., eNB 202 may perform joint encoding of a plurality of fields of DCI to support additional HARQ-ACK delay values. The additional HARQ-ACK delay values may be supported without increasing the size of DCI for communicating HARQ-ACK delays and PDSCH offsets to a UE, e.g., UE 204. In some implementations, for example, the joint encoding may refer to one field indicating multiple pieces of information. For example, an entry in a jointly encoded field may provide information about several parameters, e.g., HARQ Process ID, PDSCH offset, HARQ-ACK delay, as illustrate in 300 of FIG. 3.

In an example implementation, the eNB may perform joint encoding of a plurality of DCI fields which may include a PDSCH offset, a HARQ-ACK delay, and/or a HARQ process number to generate joint encoded index values 302 which may then communicated to the UE to indicate HARQ-ACK delay 308 and PDSCH offset 306 for the HARQ processes 304. In some implementations, for example, the PDSCH offset flag may be 1 bit in size (or length), the HARQ-ACK delay field may be 3 bits in size, and a HARQ process number field may be 4 bits in size, and the eNB may perform joint encoding of these three fields, which add up to 8 bits, to generate a total of 256 (2⁸) unique states (or index values) to support the additional HARQ-ACK delay values and/or PDSCH offsets. It should be noted that an expanded HARQ-ACK delay of 8 is also being supported to support the additional HARQ-ACK delays for 14 HARQ processes. In some implementations, for example, the plurality of DCI fields that are jointly encoded may include a HARQ-ACK bundling flag field.

As illustrated in FIG. 3, the jointed encoded index values 302 may include unique index values, 0-255, which may be used to support HARQ-ACK delay values and PDSCH offsets for 14 HARQ processes. Each index value may be associated with a HARQ process ID 304, a PDSCH offset 306, and/or a HARQ-ACK delay 308. For example, a joint encoded index value of 6 may indicate a HARQ-ACK delay of 11 and PDSCH offset of 2 for HARQ process 0. In an additional example, a joint encoded index value of 13 may indicate a HARQ-ACK delay of 8 and a PDSCH offset of 7 for HARQ process 0. In another additional example, a joint encoded index value of 243 may indicate a HARQ-ACK delay of 4 and a PDSCH offset of 7 for HARQ process 13. It should be noted that the example implementations described in this present disclosure may include support for a HARQ-ACK delay of 8 which may not have been previously supported. In addition, PDSCH offsets of 2 and 7 for each of the 14 HARQ processes are also supported.

In some implementations, for example, four joint encoded index values (e.g., 252-255) may be considered as “Reserved,” and may be used as needed, for example, for efficient signaling of RRC reconfigurations instead of lengthy RRC level signalling. In an example implementation, eNB 202 may use one of the Reserved fields (e.g., Reserved field with an index value of 252) to indicate the switching to 10 HARQ process configuration (from 14 HARQ process configuration).

Upon receiving of the switching message from the eNB, the UE may interpret the 8 bits of the three DCI fields described above separately (or independently) to determine HARQ-ACK delays and PDSCH offsets for 10 HARQ processes.

In some implementations, for example, when the UE is configured to support 14 HARQ processes, and DCI indicates a new transmission, HARQ-ACK delay values of 4, 5, 6, 7, 9, 11, 13, and 15 may be supported, similar to Table 7.3.1-2 of 36.213 for HARQ-ACK delay. In some other implementations, for example, when the UE is configured to support 10 HARQ processes, and DCI indicates a re-transmission, HARQ-ACK delay values of 4, 5, 6, 7, 8, 9, 11, and 13, and 15 may be supported (HARQ-ACK delay of 15 is replaced with 8). In other words, a HARQ-ACK delay of 8 may be supported for retransmissions.

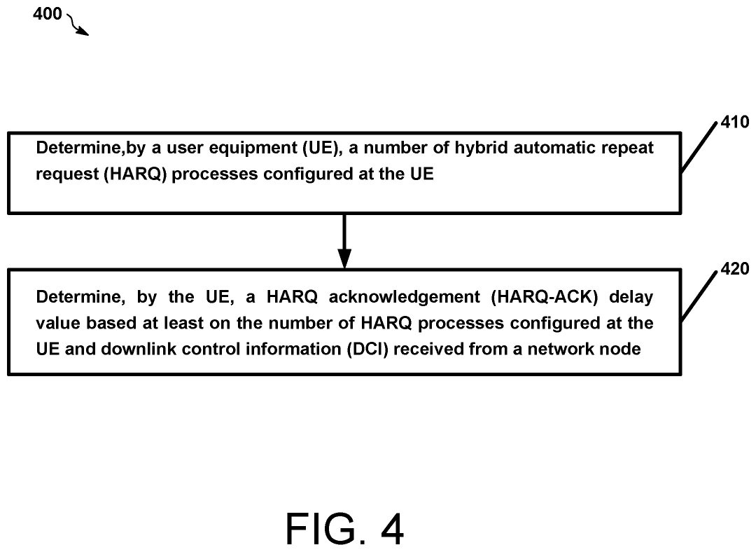

FIG. 4 is a flow chart 400 illustrating HARQ-ACK delay procedure to support at least 14 HARQ processes, according to an example implementation.

At block 410, a UE, e.g., UE 204, may determine a number of HARQ processes configured at the UE. In some implementations, for example, the number of HARQ processes may be configured by an eNB (e.g., eNB 202). In an example implementation, the eNB may configure the UE to support 14 HARQ processes. In some implementations, for example, the number of HARQ processes configured at the UE may be the maximum number of HARQ processes configured at the UE.

At block 420, the UE may determine HARQ-ACK delay value based at least on the number of HARQ processes configured at the UE and DCI received from the eNB. In some implementations, for example, the UE may determine HARQ-ACK delay based at least on joint encoded index value of a plurality of fields of DCI as described above.

Thus, additional HARQ-ACK delays and PDSCH offsets may be supported for 14 HARQ processes to support higher throughputs without increase in the size of DCI.

Additional example implementations are described herein.

Example 1. A method of communications, comprising: determining, by a user equipment (UE), a number of hybrid automatic repeat request (HARQ) processes configured at the UE; and determining, by the UE, a HARQ acknowledgement (HARQ-ACK) delay value based at least on the number of HARQ processes configured at the UE and downlink control information (DCI) received from a network node.

Example 2. The method of Example 1, wherein the number of HARQ processes configured is a maximum number of HARQ processes configured at the UE.

Example 3. The method of any of Examples 1-2, wherein the determining of the HARQ-ACK delay value further includes: determining that a first number of HARQ processes are configured at the UE; and determining, in response to the first number of HARQ processes being configured at the UE, a first HARQ-ACK delay value from a plurality of fields of the DCI that are jointly encoded.

Example 4. The method of any of Examples 1-3, wherein the plurality of fields includes: a physical downlink shared channel (PDSCH) offset field, a HARQ-ACK delay field, and a HARQ process number.

Example 5. The method of any of Examples 1-4, wherein the first number of HARQ processes is fourteen.

Example 6. The method of any of Examples 1-5, wherein the joint encoding of the plurality of fields include joint encoding of a plurality of bits of the DCI associated with the plurality of the fields.

Example 7. The method of any of Examples 1-6, wherein the plurality of fields includes eight bits of the DCI.

Example 8. The method of any of Examples 1-7, wherein the joint encoding provides 256 index values.

Example 9. The method of any of Examples 1-8, further comprising: determining, from the index values, first HARQ-ACK delay values, HARQ process numbers, and physical downlink shared channel (PDSCH) offsets.

Example 10. The method of any of Examples 1-9, wherein the first HARQ-ACK delay values include a HARQ-ACK delay value of eight.

Example 11. The method of any of Examples 1-10, wherein the 256 index values include at least four reserved fields.

Example 12. The method of any of Examples 1-11, further comprising:

receiving radio resource control (RRC) reconfiguration information from the network node, where in the RRC reconfiguration information indicates switching to ten HARQ processes.

Example 13. The method of any of Examples 1-12, wherein the RRC reconfiguration information indicating the switching to ten HARQ processes is received via at least one of the at least four reserved fields.

Example 14. The method of Example 1, wherein the determining of the HARQ-ACK delay value further includes: determining that a second number of HARQ processes are configured at the UE; and determining, in response to determining that the second number of HARQ processes are configured at the UE, a second HARQ-ACK delay value from a parameter of the DCI.

Example 15. The method of any of Examples 1 and 14, wherein the second HARQ-ACK delay value is determined from a HARQ-ACK delay parameter in the DCI.

Example 16. The method of any of Examples 1 and 14-15, wherein the second number of HARQ processes is ten.

Example 17. The method of Example 1, wherein the determining of the HARQ-ACK delay value further includes: determining that a first number of HARQ processes are configured at the UE; and determining, in response to the first number of HARQ processes being configured at the UE, a HARQ-ACK delay value from a HARQ-ACK delay field and a new data identifier (NDI) field of the DCI.

Example 18. The method of any of Examples 1 and 17, wherein the first number of HARQ processes is fourteen.

Example 19. The method of any of Examples 1 and 17-18, wherein a value in the NDI field indicates whether a transmission is a new transmission or a re-transmission.

Example 20. The method of Example 1, wherein the determining of the HARQ-ACK delay value further includes: determining that a second number of HARQ processes are configured at the UE; and determining, in response to the second number of HARQ processes being configured at the UE, a HARQ-ACK delay value from a HARQ-ACK delay field of the DCI.

Example 21. The method of any of Examples 1 and 20, wherein the second number of HARQ processes is fourteen.

Example 22. The method of any of Examples 1-21, wherein the network node is an eNB.

Example 23. An apparatus comprising means for performing the method of any of Examples 1-22.

Example 24. A non-transitory computer-readable storage medium comprising instructions stored thereon that, when executed by at least one processor, are configured to cause a computing system to perform the method of any of Examples 1-22.

Example 25. An apparatus comprising: at least one processor; and at least one memory including computer program code; the at least one memory and the computer program code configured to, with the at least one processor, cause the apparatus at least to perform the method of any of Examples 1-22.

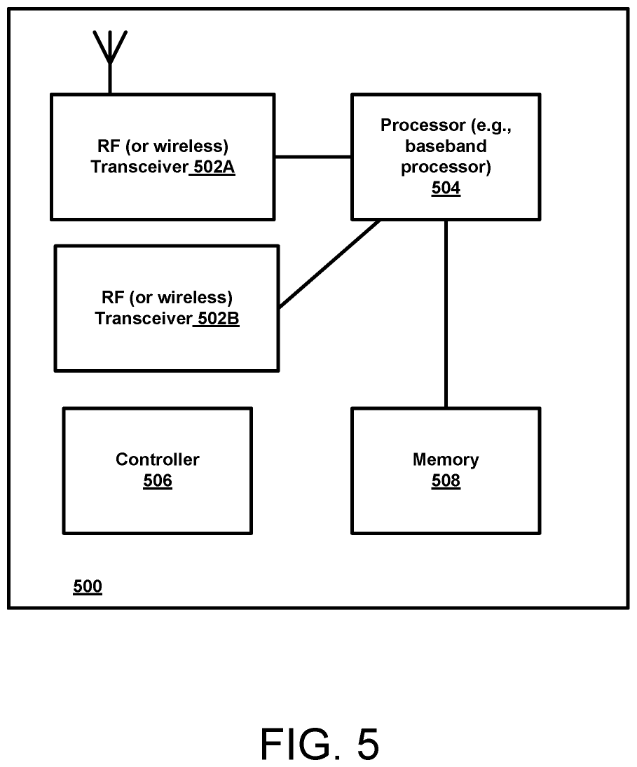

FIG. 5 is a block diagram of a wireless station (e.g., user equipment (UE)/user device or AP/gNB/MgNB/SgNB) 500 according to an example implementation. The wireless station 500 may include, for example, one or more RF (radio frequency) or wireless transceivers 502A, 502B, where each wireless transceiver includes a transmitter to transmit signals and a receiver to receive signals. The wireless station also includes a processor or control unit/entity (controller) 504/508 to execute instructions or software and control transmission and receptions of signals, and a memory 506 to store data and/or instructions.

Processor 504 may also make decisions or determinations, generate frames, packets or messages for transmission, decode received frames or messages for further processing, and other tasks or functions described herein. Processor 504, which may be a baseband processor, for example, may generate messages, packets, frames or other signals for transmission via wireless transceiver 502 (502A or 502B). Processor 504 may control transmission of signals or messages over a wireless network, and may control the reception of signals or messages, etc., via a wireless network (e.g., after being down-converted by wireless transceiver 502, for example). Processor 504 may be programmable and capable of executing software or other instructions stored in memory or on other computer media to perform the various tasks and functions described above, such as one or more of the tasks or methods described above. Processor 504 may be (or may include), for example, hardware, programmable logic, a programmable processor that executes software or firmware, and/or any combination of these. Using other terminology, processor 504 and transceiver 502 together may be considered as a wireless transmitter/receiver system, for example.

In addition, referring to FIG. 5, a controller (or processor) 508 may execute software and instructions, and may provide overall control for the station 500, and may provide control for other systems not shown in FIG. 5, such as controlling input/output devices (e.g., display, keypad), and/or may execute software for one or more applications that may be provided on wireless station 500, such as, for example, an email program, audio/video applications, a word processor, a Voice over IP application, or other application or software. Moreover, a storage medium may be provided that includes stored instructions, which when executed by a controller or processor may result in the processor 504, or other controller or processor, performing one or more of the functions or tasks described above.

According to another example implementation, RF or wireless transceiver(s) 502A/502B may receive signals or data and/or transmit or send signals or data. Processor 504 (and possibly transceivers 502A/502B) may control the RF or wireless transceiver 502A or 502B to receive, send, broadcast or transmit signals or data.

The aspects are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (JOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

1-25. (canceled)

26. A method of communications, comprising:
determining, by a user equipment (UE), a number of hybrid automatic repeat request (HARQ) processes configured at the UE; and
determining, by the UE, a HARQ acknowledgement (HARQ-ACK) delay value based at least on the number of HARQ processes configured at the UE and downlink control information (DCI) received from a network node.

27. The method of claim 26, wherein the number of HARQ processes configured is a maximum number of HARQ processes configured at the UE.

28. The method of claim 26, wherein the determining of the HARQ-ACK delay value further includes:
determining that a first number of HARQ processes are configured at the UE; and
determining, in response to the first number of HARQ processes being configured at the UE, a first HARQ-ACK delay value from a plurality of fields of the DCI that are jointly encoded.

29. The method of claim 26, wherein the plurality of fields includes:
a physical downlink shared channel (PDSCH) offset field,
a HARQ-ACK delay field, and
a HARQ process number.

30. The method of claim 26, wherein the first number of HARQ processes is fourteen.

31. The method of claim 26, wherein the joint encoding of the plurality of fields include joint encoding of a plurality of bits of the DCI associated with the plurality of the fields.

32. The method of claim 26, wherein the plurality of fields includes eight bits of the DCI.

33. The method of claim 26, wherein the joint encoding provides 256 index values.

34. The method of claim 26, further comprising:
determining, from the index values, first HARQ-ACK delay values, HARQ process numbers, and physical downlink shared channel (PDSCH) offsets.

35. The method of claim 26, wherein the first HARQ-ACK delay values include a HARQ-ACK delay value of eight.

36. The method of claim 26, wherein the 256 index values include at least four reserved fields.

37. The method of claim 26, further comprising:
receiving radio resource control (RRC) reconfiguration information from the network node, where in the RRC reconfiguration information indicates switching to ten HARQ processes.

38. The method of claim 26, wherein the RRC reconfiguration information indicating the switching to ten HARQ processes is received via at least one of the at least four reserved fields.

39. The method of claim 26, wherein the determining of the HARQ-ACK delay value further includes:
determining that a second number of HARQ processes are configured at the UE; and
determining, in response to determining that the second number of HARQ processes are configured at the UE, a second HARQ-ACK delay value from a parameter of the DCI.

40. The method of claim 26, wherein the second HARQ-ACK delay value is determined from a HARQ-ACK delay parameter in the DCI.

41. The method of claim 26, wherein the second number of HARQ processes is ten.

42. The method of claim 26, wherein the determining of the HARQ-ACK delay value further includes:
determining that a first number of HARQ processes are configured at the UE; and
determining, in response to the first number of HARQ processes being configured at the UE, a HARQ-ACK delay value from a HARQ-ACK delay field and a new data identifier (NDI) field of the DCI.

43. The method of claim 26, wherein the first number of HARQ processes is fourteen.

44. The method of claim 26, wherein a value in the NDI field indicates whether a transmission is a new transmission or a re-transmission.

45. The method of claim 26, wherein the determining of the HARQ-ACK delay value further includes:
determining that a second number of HARQ processes are configured at the UE; and
determining, in response to the second number of HARQ processes being configured at the UE, a HARQ-ACK delay value from a HARQ-ACK delay field of the DCI.

46. The method of claim 26, wherein the second number of HARQ processes is fourteen.

47. The method of claim 26, wherein the network node is an eNB.

48. A non-transitory computer-readable storage medium comprising instructions stored thereon that, when executed by at least one processor, are configured to cause a computing system to perform the method of claim 26.

49. An apparatus comprising:
at least one processor; and
at least one memory including computer program code;
the at least one memory and the computer program code configured to, with the at least one processor, cause the apparatus at least to perform the method of claim 26.
